(19) United States
(12) Patent Application Publication
(10) Pub. No.: US 2022/0072839 A1
(43) Pub. Date: Mar. 10, 2022

(54) MULTI-LAYER FILMS AND METHODS OF MANUFACTURING THE SAME

(71) Applicant: COVERIS HOLDING CORP., Chicago, IL (US)

(72) Inventors: Thomas R. LEE, Chicago, IL (US); Scott HOWELLS, Chicago, IL (US); Jason MEYER, Chicago, IL (US); Rusty BRIGHT, Chicago, IL (US)

(73) Assignee: Transcontinental Holding Corp., Chicago, IL (US)

(21) Appl. No.: 16/625,504

(22) PCT Filed: Jun. 20, 2018
(86) PCT No.: PCT/US2018/038485

§ 371 Date: Dec. 20, 2019

Related U.S. Application Data
(60) Provisional application No. 62/523,155, filed on Jun. 21, 2017.

(51) Int. Cl. B32B 27/36; B32B 27/34; B32B 27/32; B32B 27/08; B32B 27/30; B32B 7/12; B32B 27/18; B29C 48/00; B32B 1/08; B29C 48/10; B29C 48/21; B29C 48/91; B29C 71/02

(52) U.S. Cl. CPC B32B 27/36; B29L 2023/001; B32B 27/32; B32B 27/08; B32B 27/306; B32B 7/12; B32B 27/18; B32B 27/327; B29C 48/0018; B29C 48/022; B32B 1/08; B29C 48/10; B29C 48/21; B29C 48/9105; B29C 71/02; B32B 2307/30; B32B 2270/00; B32B 2307/306; B32B 2307/406; B32B 2250/24; B32B 2307/7244; B32B 2260/046; B32B 2250/05; B32B 2553/00; B32B 2307/75; B32B 2307/518; B32B 2597/00; B29C 2071/022; B32B 27/34

(57) ABSTRACT

The present disclosure relates to multi-layer film structures and methods of manufacturing the same. The films can be oriented and heat shrinkable. The films can include an ethylene vinyl alcohol layer. In certain instances, the films do not include an individual polyamide layer.

### CROSS-REFERENCE TO RELATED APPLICATIONS

This patent application claims priority to U.S. Provisional Patent Application No. 62/523,155, entitled “MULTI-LAYER FILMS AND METHODS OF MANUFACTURING THE SAME,” filed Jun. 21, 2017, which is incorporated herein by reference in its entirety.

### TECHNICAL FIELD

The present disclosure relates generally to multi-layer film structures and methods of manufacturing the same.

### BRIEF DESCRIPTION OF THE DRAWINGS

The written disclosure herein describes illustrative embodiments that are non-limiting and non-exhaustive. Reference is made to certain of such illustrative embodiments that are depicted in the figures (which are not necessary drawn to scale), in which:

FIG. 1 is a cross-sectional plan view of a multi-layer film structure, according to an embodiment of the present disclosure.

FIG. 2 is a cross-sectional plan view of a multi-layer film structure, according to another embodiment of the present disclosure.

### DETAILED DESCRIPTION

The present disclosure relates to multi-layer film structures (or multi-layer film constructions) and methods of manufacturing the same. The films can be oriented and/or heat shrinkable. The films can also exhibit a glossy and/or shiny outer or exterior surface. The films can include a barrier layer, such as an ethylene vinyl alcohol (EVOH) layer, which can impart oxygen barrier properties. The films can also be relatively stable and exhibit little to no environmental shrinkage (or shrinkage due to absorbed moisture and/or temperatures from the environment). In certain instances, the barrier layer includes ethylene vinyl alcohol and an acid modified polyolefin. In further instances, the films do not include a separate and/or discrete polyamide (or substantially pure polyamide) layer. The absence of a separate and/or discrete polyamide layer (or substantially pure polyamide layer) can be advantageous in avoiding and/or minimizing the effects of environmental shrinkage, yet the films are still capable of being oriented and heat shrinkable as further detailed below.

For the purposes of promoting an understanding of the principles of the disclosure provided herein, reference will now be made to the embodiments illustrated in the drawings and specific language will be used to describe the same. It will be readily understood with the aid of the present disclosure that the components of the embodiments, as generally described and illustrated in the figures herein, could be arranged and designed in a wide variety of different configurations. Thus, the following more detailed description of various embodiments, as represented in the figures, is not intended to limit the scope of the disclosure, but is merely representative of various embodiments. In some cases, well-known structures, materials, or operations are not shown or described in detail. While the various aspects of the embodiments are presented in drawings, the drawings are not necessarily drawn to scale unless specifically indicated.

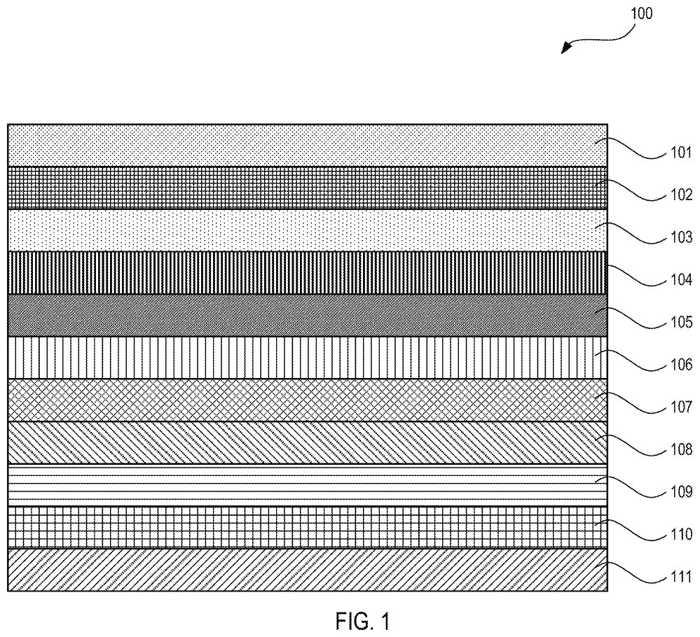

FIG. 1 depicts a multi-layer film or multi-layer film structure 100 according to an embodiment of the present disclosure. As shown in FIG. 1, the film 100 can include a plurality of layers, such as a first layer 101, second layer 102, third layer 103, fourth layer 104, fifth layer 105, sixth layer 106, seventh layer 107, eighth layer 108, ninth layer 109, tenth layer 110, and eleventh layer 111. More or fewer layers can also be used. In certain embodiments, the first layer 101 and the eleventh layer 111 can be referred to as outer layers, and each of the second 102 through tenth layers 110 can be referred to as an inner layer.

In some embodiments, the first layer 101 can be configured to be an outer, exterior layer or outermost layer of the film 100, or a packaging structure made from the film 100. In certain embodiments, the first layer 101 comprises between about 5% and about 30%, between about 5% and about 25%, between about 5% and about 20%, or between about 5% and about 15% by volume of the film 100. In other embodiments, the first layer 101 comprises between about 10% and about 30%, between about 10% and about 25%, or between about 10% and about 20% by volume of the film 100.

The first layer 101 can include or be constructed from various materials. For example, in some embodiments, the first layer 101 comprises a polyester, such as polyethylene terephthalate (PET), or a blend thereof. In other embodiments, the first layer 101 comprises polyamide (e.g., nylon) or polypropylene. Copolymers or blends of the above-identified materials can also be used. In certain embodiments, the first layer 101 comprises a material (e.g., such as a polyester) having a melting point of between about 200° C. and about 280° C., between about 210° C. and about 270° C., or between about 220° C. and about 260° C. In some embodiments, the first layer 101 imparts heat resistance to the film 100. The first layer 101 can also impart a shiny and/or glossy appearance to the film 100. In certain embodiments, the first layer 101 also serves as a barrier to oxygen and/or other gases or elements. The first layer 101 can also be suitable for marking, inscribing, and/or printing indicia thereon.

One or more layers (e.g., such as the second layer 102) can include one or more tie and/or adhesive materials. The tie and/or adhesive materials can be used to adhere a surface of one layer to a surface of another layer (e.g., such as a surface of the first layer 101 with a surface of the third layer 103). For example, in some embodiments, the second layer 102 can include one or more tie and/or adhesive materials. In such embodiments, the second layer 102 can be referred to as a tie and/or adhesive layer. In some embodiments, the second layer 102 comprises between about 1% and about 10% by volume of the film 100. In other embodiments, the second layer 102 comprises between about 1% and about 15%, or between about 5% and about 15% by volume of the film 100.

Exemplary tie and/or adhesive materials that can be used (e.g., in the second layer 102) include, but are not limited to, solvent-based adhesives, solventless adhesives, elastomer-based adhesives, ethylene polymer or copolymer-based adhesives, propylene polymer or copolymer-based adhesives, and/or blends or derivatives thereof. For example, in some embodiments, ethylene polymer or copolymer-based adhesives can comprise an ethylene polymer or copolymer that is chemically modified with anhydride (e.g., maleic anhydride grafted) or other functional groups. Chemically modified (e.g., anhydride modified) elastomer-based adhesives can also be used.

One or more of the inner layers (e.g., such as the third layer 103, fourth layer, 104, fifth layer 105, sixth layer 106 and seventh layer 107) can include one or more polymers or copolymers, polyolefins (e.g., polyolefin polymers and copolymers), plastomers, elastomers, terpolymers, and/or blends thereof. In certain embodiments, each of the third layer 103, fourth layer 104, fifth layer 105, sixth layer 106, and seventh layer 107 (each of which can include one or more polymers or copolymers, polyolefins (e.g., polyolefin polymers and copolymers), plastomers, elastomers, terpolymers, and/or blends thereof) comprises between about 1% and about 15%, between about 1% and about 10%, or between about 5% and about 15% by volume of the film 100. In other embodiments, the third layer 103, fourth layer 104, fifth layer 105, sixth layer 106, and seventh layer 107 (each of which can include one or more polymers or copolymers, polyolefins (e.g., polyolefin polymers and copolymers), plastomers, elastomers, terpolymers, and/or blends thereof) comprise a combined total of between about 15% and about 70%, between about 15% and about 60%, or between about 20% and about 50% by volume of the film 100. In yet other embodiments, the third layer 103, fourth layer 104, fifth layer 105, sixth layer 106, and seventh layer 107 (each of which can include one or more polymers or copolymers, polyolefins (e.g., polyolefin polymers and copolymers), plastomers, elastomers, terpolymers, and/or blends thereof) comprise a combined total of between about 25% and about 70%, or between about 25% and about 60% by volume of the film 100. In certain embodiments, the one or more polymers or copolymers, polyolefins (e.g., polyolefin polymers and copolymers), plastomers, elastomers, terpolymers, and/or blends thereof can aid in orientation of the film structure 100.

Exemplary plastomers that can be used include, but are not limited to, olefinic plastomers (e.g., polyolefin plastomers), propylene or polypropylene-based plastomers, ethylene or polyethylene based plastomers, propylene-ethylene or propylene-ethylene-based plastomers and/or derivatives thereof. Exemplary elastomers include, but are not limited to, olefinic elastomers (e.g., polyolefin elastomers), propylene or polypropylene-based elastomers, ethylene or polyethylene-based elastomers, and/or derivatives thereof. Polyolefin copolymers such as ethylene vinyl acetate copolymers and/or derivatives thereof can also be used. Octene or octene-based plastomers, elastomers, and/or derivatives thereof can also be used. Terpolymers (e.g., polyolefin terpolymers) and/or ionomers can also be used. The plastomers and/or elastomers can also be metallized. In further embodiments, metallocene or metallocene-based (or metallocene grade) plastomers, elastomers, and/or derivatives thereof can be used.

In some embodiments, polyolefin copolymers such as ethylene vinyl acetate copolymers and/or derivatives thereof are used in one or more of the inner layers (e.g., such as the third layer 103, fourth layer 104, fifth layer 105, sixth layer 106 and seventh layer 107). In certain of such embodiments, the ethylene vinyl acetate copolymers comprise a vinyl acetate weight percent of between about 5% and about 50%, or between about 7.5% and about 40%. In other embodiments, the ethylene vinyl acetate copolymers comprise a vinyl acetate weight percent of between about 7.5% and about 30%, between about 7.5% and about 25%, between about 7.5% and about 20%, between about 10% and about 20%, or between about 10% and about 18%. Blends of ethylene vinyl acetate and one or more additional polymers or copolymers, polyolefins (e.g., polyolefin polymers and copolymers), plastomers, elastomers, terpolymers, and/or other olefin resins or materials can also be used.

In certain embodiments, the plastomers and/or elastomers can be blended with one or more additional plastomers, elastomers, and/or other olefin resins or materials. For example, in particular embodiments, a blend of a plastomer and a copolymer comprising one or more of ethylene, propylene, and/or butene is used. In particular embodiments, a blend of a first plastomer and/or elastomer component and a second plastomer and/or elastomer component can be used. For example, in one embodiment, a first plastomer and/or elastomer component comprises one or more of ethylene, propylene, and/or butene, and a second plastomer and/or elastomer component comprises a propylene-ethylene based plastomer. Exemplary blends of the first and second plastomer and/or elastomer components in such embodiments can include between about 50:50 and about 95:5 by volume (first component:second component), or between about 60:40 and about 80:20 by volume (first component:second component). Other ratios can also be used. It will also be appreciated that any of the above mentioned plastomers and/or elastomers can be included in the first and/or second components of a blend. For example, polyolefin copolymers such as ethylene vinyl acetate could be used in a blend as discussed above. Additionally, in certain embodiments, additional components can also be added to the blend, such as a third component, fourth component, fifth component, etc.

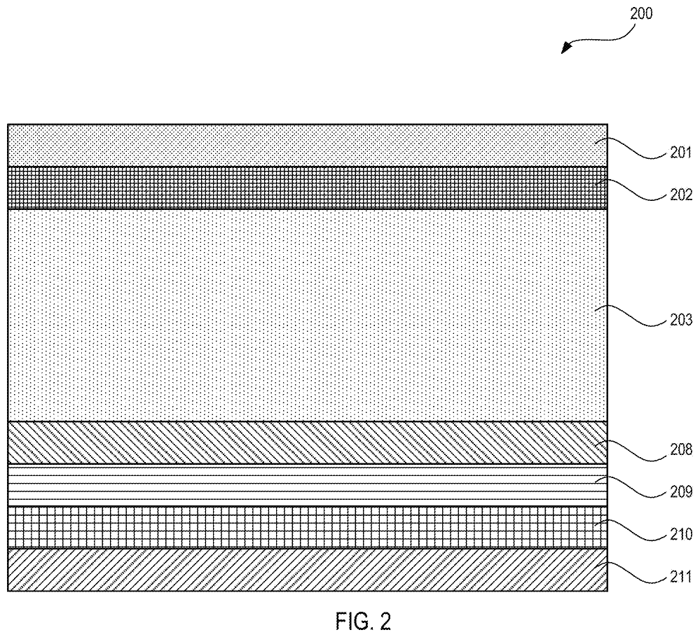

In various embodiments, the third layer 103, fourth layer 104, fifth layer 105, sixth layer 106, and seventh layer 107 each comprise the same material. In such embodiments, the third layer 103, fourth layer 104, fifth layer 105, sixth layer 106, and seventh layer 107 can be described as a single layer, or as less than five layers. In further embodiments, the third layer 103, fourth layer 104, fifth layer 105, sixth layer 106, and seventh layer 107 are formed or extruded as a single layer rather than five separate and individual layers (e.g., such as is depicted in FIG. 2 below). In still further embodiments, one or more additional layers comprising the same material as the third layer 103, fourth layer 104, fifth layer 105, sixth layer 106, and seventh layer 107 are also extruded. One or more fewer layers can also be extruded. Additionally, in some embodiments, one or more of the third layer 103, fourth layer 104, fifth layer 105, sixth layer 106, and seventh layer 107 comprise different materials.

At least one inner layer (e.g., without limitation, the ninth layer 109) can comprise a barrier layer. In some embodiments, the barrier layer (e.g., ninth layer 109) comprises between about 1% and about 25%, between about 1% and about 20%, or between about 5% and about 15% by volume of the film 100.

In particular embodiments, the barrier layer (e.g., ninth layer 109) includes a copolymer of ethylene vinyl alcohol (EVOH). In certain embodiments, the EVOH layer can serve as a barrier to oxygen and/or other gases or elements. Various grades of EVOH can be used, including, but not limited to, EVOH containing between about 29 mol % ethylene and about 47 mol % ethylene, between about 32 mol % ethylene and about 44 mol % ethylene, and between about 34 mol % ethylene and about 40 mol % ethylene. Other grades of EVOH can also be used.

In some embodiments, the barrier layer (e.g., ninth layer 109) includes a blend of EVOH and one or more additives. Exemplary additives that can be used include, but are not limited to, acid modified polyolefins. In certain of such embodiments, the polyolefin comprises a copolymer of ethylene and an alpha olefin (an ethylene/alpha-olefin copolymer or ethylene alpha-olefin copolymer). And in further of such embodiments, the polyolefin is modified or functionalized with maleic anhydride. For instance, maleic anhydride can be grafted onto the polyolefin. In particular embodiments, the polyolefin includes a maleic anhydride grafted ethylene alpha olefin copolymer. The polyolefin (e.g., maleic anhydride grafted ethylene alpha olefin copolymer) can also be an acid modified polyolefin (e.g., an acid modified maleic anhydride grafted ethylene alpha olefin copolymer).

In some embodiments, the acid modified polyolefin (e.g., acid modified maleic anhydride grafted ethylene alpha olefin copolymer) comprises a melt flow rate (at 190° C./2.16 kg) of between about 1.2 and about 1.8 g/10 min as determined by ASTM D1238. In additional embodiments, the acid modified polyolefin (e.g., acid modified maleic anhydride grafted ethylene alpha olefin copolymer) comprises a melt flow rate (at 230° C./2.16 kg) of between about 2.7 and about 3.3 g/10 min as determined by ASTM D1238.

Various amounts of additives (e.g., acid modified polyolefins) can be used. For example, in some embodiments, the barrier layer comprises between about 1% and about 15%, between about 1% and about 10%, or between about 3% and about 8% by volume of an acid modified polyolefin (e.g., acid modified maleic anhydride grafted ethylene alpha olefin copolymer). The remainder of the barrier layer can comprise EVOH (or a blend thereof, such as a blend of EVOH and a polyamide, etc.).

In certain embodiments, the amount of additives (e.g., acid modified polyolefins) can be dependent upon the thickness of the barrier layer (e.g., the EVOH layer) and/or the thickness of the film 100. For example, in certain embodiments, a 1.8 mil film 100 can comprise a barrier layer having between about 3% and about 8% by volume of an acid modified polyolefin (e.g., acid modified maleic anhydride grafted ethylene alpha olefin copolymer), a 2.0 mil film 100 can comprise a barrier layer having between about 5% and about 10% by volume of an acid modified polyolefin (e.g., acid modified maleic anhydride grafted ethylene alpha olefin copolymer), and a 2.2 mil film 100 can comprise a barrier layer having between about 8% and about 13% by volume of an acid modified polyolefin (e.g., acid modified maleic anhydride grafted ethylene alpha olefin copolymer). Other amounts can also be used.

In some embodiments, use of additives (e.g., acid modified polyolefins) can impact the softness (or stiffness) of the film 100. For example, films 100 comprising a barrier layer including EVOH and an acid modified polyolefin (e.g., acid modified maleic anhydride grafted ethylene alpha olefin copolymer) can exhibit increased softness (or decreased stiffness) as compared to a film 100 comprising a barrier layer including EVOH without an acid modified polyolefin.

In certain embodiments, the barrier layer (e.g., ninth layer 109) includes a blend of EVOH and a polyamide. For example, the barrier layer (e.g., ninth layer 109) can include a blend of EVOH and a polyamide terpolymer or a copolyamide. Exemplary blends can include an EVOH:polyamide blend that is greater than about 50%, greater than about 60%, greater than about 70%, greater than about 80%, greater than about 90%, greater than about 91%, greater than about 92%, greater than about 93%, greater than about 94%, greater than about 95%, greater than about 96%, greater than about 97%, greater than about 98%, or greater than about 99% by volume EVOH.

Other exemplary blends can include a ratio of EVOH:polyamide of between about 50:50 and about 99:1, between about 60:40 and about 90:10, and between about 70:30 and about 80:20 by volume. In other embodiments, the blend can include a ratio of EVOH:polyamide of between about 90:10 and about 99:1, between about 91:9 and about 99:1, between about 92:8 and about 99:1, between about 93:7 and about 99:1, between about 94:6 and about 99:1, between about 95:5 and about 99:1, between about 96:4 and about 99:1, between about 97:3 and about 99:1, or between about 98:2 and about 99:1 by volume. Blends of EVOH, an acid modified polyolefin, and a polyamide can also be used. In other embodiments, blends of EVOH and polyamide are not used. For example, the EVOH layer or barrier layer can be devoid of a polyamide.

Further, in some embodiments, the film 100 does not include any separate or discrete polyamide layers (or substantially pure polyamide layers). For example, in some of such embodiments, the film 100 does not include any layers having greater than about 60%, greater than about 70%, greater than about 80%, greater than about 90%, or greater than about 95% by volume polyamide. In further embodiments, the film 100 does not include any polyamide layers adjacent to the EVOH layer. In certain embodiments, the only polyamide materials in the film 100 are blended with the EVOH. And in particular embodiments, no polyamide materials are used at all, and the film 100 is devoid of polyamide materials.

Additional tie and/or adhesive layers can also be included as desired. In the illustrated embodiment, for example, the eighth layer 108 and tenth layer 110 (e.g., the layers adjacent to a barrier layer, ninth layer 109) can include one or more tie and/or adhesive materials. In such embodiments, the eighth layer 108 and tenth layer 110 can be referred to as tie and/or adhesive layers, and can be used to adhere the barrier layer (e.g., ninth layer 109) to adjacent layers. In some embodiments, each of the eighth layer 108 and tenth layer 110 comprises between about 1% and about 10% by volume of the film 100. In other embodiments, each of the eighth layer 108 and tenth layer 110 comprises between about 1% and about 15% or between about 5% and about 15% by volume of the film 100.

Any of the above-identified tie and/or adhesive materials can be used. For example, illustrative tie and/or adhesive materials that can be used in the eighth layer 108 and tenth layer 110 (the layers adjacent to the barrier layer) include, but are not limited to, solvent-based adhesives, solventless adhesives, elastomer-based adhesives, ethylene polymer or copolymer-based adhesives, propylene polymer or copolymer-based adhesives, and/or blends or derivatives thereof. For example, in some embodiments, the elastomer-based adhesives are chemically modified with anhydride or other functional group.

The second outer layer of the film 100 (e.g., the eleventh layer 111) can include one or more sealant materials. In such embodiments, the layer (e.g., eleventh layer 111) can be referred to as a sealant layer. Sealant materials can provide, for instance, sealing properties and/or sealing functionality to the film 100. Sealant materials include, for instance, materials that may be used or configured to form a seal upon the application of increased pressure and/or heat. In some embodiments, the sealant layer (e.g., eleventh layer 111) comprises between about 10% and about 40%, between about 15% and about 35%, between about 15% and about 30%, or between about 15% and about 25% by volume of the film 100.

Exemplary sealant materials that can be used include, but are not limited to, plastomers, ethylene octene plastomers (or ethylene-based octene plastomers), metallocene ethylene copolymers (e.g., metallocene ethylene hexene copolymers), and derivatives and/or blends thereof. In some embodiments, the sealant layer comprises between about 50% and about 99% by volume plastomers or other sealant materials. In further embodiments, the sealant layer comprises between about 50% and about 99% by volume plastomers, and between about 1% and about 50% by volume metallocene ethylene copolymers (e.g., metallocene ethylene hexene copolymers).

As can be appreciated, in some embodiments, the eleventh layer 111 can be referred to as an outer layer of the film 100. When referring to a package made from the film 100, the sealant layer (or eleventh layer 111) can also be referred to as the innermost layer, or the layer closest to or facing the product to be packaged.

As can be appreciated, the film 100 (or any layer thereof, e.g., layer 101, 102, 103, 104, 105, 106, 107, 108, 109, 110, or 111) can further and/or optionally comprise one or more additional known materials that add strength, stiffness, heat resistance, durability, printability, and/or other enhanced characteristics to the film 100. Additionally, one or more known film additives may be optionally added to the film 100 (or any layer thereof, e.g., layer 101, 102, 103, 104, 105, 106, 107, 108, 109, 110, or 111), such as slip agents, anti-blocking agents, processing additives, colorants, odor inhibitors, oxygen inhibitors, and the like. One or more coatings (e.g., varnishes) can also optionally be added to the film 100 as desired.

The layers 101, 102, 103, 104, 105, 106, 107, 108, 109, 110, 111 can also be directly adhered to each adjacent layer. For example, a surface of the first layer 101 can be directly adhered to a surface of the second layer 102, and so forth. Further, as can be appreciated, one or more tie or adhesive layers can facilitate adhesion between two layers. For example, the first layer 101 can be adhered to the third layer 103 via tie or adhesive layer 102.

The order and/or arrangement of the layers (e.g., 101, 102, 103, 104, 105, 106, 107, 108, 109, 110, 111) in the depicted film 100 are intended to be exemplary and not limiting in any way. For example, the order and/or arrangement of the layers (e.g., 101, 102, 103, 104, 105, 106, 107, 108, 109, 110, 111) can be varied as desired. For instance, the order and/or arrangement of the barrier layer can be altered depending on the desired film structure. Further, in some embodiments, one or more layers need not be included. For example, one or more tie and/or adhesive layers need not be included depending on the materials used in the other layers (e.g., some materials need not require a tie and/or adhesive layer to adhere to an adjacent layer).

With continued reference to FIG. 1, in certain embodiments the percentage of the layers within the film 100 can comprise the following: first layer 101: between about 5% and about 30% or between about 5% and about 15% by volume of the film 100; second layer 102: between about 1% and about 15% or between about 1% and about 10% by volume of the film 100; third layer 103: between about 1% and about 15% or between about 5% and about 15% by volume of the film 100; fourth layer 104: between about 1% and about 15% or between about 5% and about 15% by volume of the film 100; fifth layer 105: between about 1% and about 15% or between about 5% and about 15% by volume of the film 100; sixth layer 106: between about 1% and about 15% or between about 5% and about 15% by volume of the film 100; seventh layer 107: between about 1% and about 15% or between about 5% and about 15% by volume of the film 100; eighth layer 108: between about 1% and about 15% or between about 1% and about 10% by volume of the film 100; ninth layer 109: between about 1% and about 20% or between about 5% and about 15% by volume of the film 100; tenth layer 110: between about 1% and about 15% or between about 1% and about 10% by volume of the film 100; and eleventh layer 111: between about 10% and about 40% or between about 15% and about 25% by volume of the film 100.

The film 100 can also be various thicknesses. For example, in certain embodiments, the thickness of the film 100 can be between about 1.0 mil and about 10.0 mil, between about 1.0 mil and about 8.0 mil, between about 1.0 mil and about 6.0 mil, or between about 1.0 mil and about 4.0 mil.

The film 100 can be heat shrinkable in one or more directions. For example, in some embodiments, the film 100 can be heat shrinkable in each direction (e.g., cross-machine direction and machine direction), or at least one direction, by between about 10% and about 60%; between about 15% and about 55%; between about 20% and about 50%; between about 25% and about 50%; between about 30% and about 50%; between about 35% and about 50%; or between about 35% and about 45%, at 200° F. In other embodiments, the film 100 can be heat shrinkable in each direction (e.g., cross-machine direction and machine direction), or at least one direction, by between about 30% and about 80%; between about 35% and about 75%; between about 40% and about 70%; between about 45% and about 70%; between about 45% and about 65%, or between about 50% and about 65%, at 200° F.

The film 100 can also be oriented or biaxially oriented. For example, in some embodiments, the film 100 can comprise an orientation factor in the cross-machine direction of between about 2.8-4.0, between about 3.0-4.0, between about 3.2-3.8, or between about 3.4-3.6. The films can also comprise an orientation factor in the machine direction of between about 2.0-3.5, between about 2.2-3.3, between about 2.4-3.0, or between about 2.4-2.8.

In certain embodiments, the film 100 exhibits one or more desired properties, including, but not limited to, gloss, haze, and/or seal strength. For example, in some embodiments, the film 100 exhibits a gloss, which can be measured in accordance with ASTM D-2457, of between about 85% and about 100%, or between about 88% and about 95%. In further embodiments, the film 100 exhibits a haze, which can be measured in accordance with ASTM D1003, of between about 5% and about 10%, or between about 6% and about 8%. In still further embodiments, the film 100 exhibits a peak seal strength, which can be measured in accordance with ASTM F-88, (0.55 sec dwell, 15-20 psi, 220-280° F., 1 inch wide samples pulled at 5 inches/min with 90° tail) of between about 8 lbs and about 15 lbs, or between about 10 lbs and about 13 lbs.

FIG. 2 depicts a multi-layer film structure 200 according to another embodiment of the present disclosure. As shown in FIG. 2, in some embodiments, the film 200 includes one or more fewer inner layers (e.g., 202, 203, 208, 209, 210) than the film 100 depicted in FIG. 1. For example, in a particular embodiment, the film 200 comprises a first layer 201, a second layer 202, a third layer 203, a fourth layer 208, and fifth layer 209, a sixth layer 210, and a seventh layer 211.

In a particular embodiment, the first layer 201 is analogous to the first layer 101 of the film 100 depicted in FIG. 1 and described above. For example, the first 201 can include any of the above-mentioned materials identified in relation to the first layer 101. One or more layers (e.g., such as the second layer 202) can include one or more tie and/or adhesive materials, which can include any of the above-mentioned tie and/or adhesive materials. The third layer 203 can comprise one or more polymers or copolymers, polyolefins (e.g., polyolefin polymers and copolymers), plastomers, elastomers, terpolymers, and/or blends thereof, and can be analogous to the third layer 103, fourth layer 104, fifth layer 105, sixth layer 106, and seventh layer 107 depicted in FIG. 1 and described above.

In certain embodiments, the third layer 203 comprises a total of between about 15% and about 70%, between about 15% and about 60%, between about 20% and about 50%, between about 25% and about 70%, or between about 25% and about 60% by volume of the film 200. As described above with respect to the third layer 103, fourth layer 104, fifth layer 105, sixth layer 106, and seventh layer 107, the third layer 203 can also include any of the above-mentioned polymers or copolymers, polyolefins (e.g., polyolefin polymers and copolymers), plastomers, elastomers, terpolymers, and/or blends thereof. For example, the third layer 203 can include a polyolefin copolymer such as ethylene vinyl acetate.

At least one layer (e.g., such as the fifth layer 209) can comprise a barrier layer, such as the barrier layer described above with respect to FIG. 1. Any of the above-mentioned barrier materials can be included (e.g., EVOH). Like the embodiment of FIG. 1, the film 200 of FIG. 2 can also include additional tie and/or adhesive layers (e.g., the fourth layer 208 and sixth layer 210). For example, tie and/or adhesive layers can be disposed adjacent to the barrier layer (e.g., fifth layer 209). The second outer layer 211 can also include one or more sealant materials, like the second outer layer 111. Any of the above-identified sealant materials can be used.

It will also be appreciated that the multi-layer film 200 can exhibit similar properties and/or characteristics to those described above with respect to FIG. 1, including but not limited to, thickness, shrinkage, orientation, gloss, haze, and/or peak seal strength.

Methods of manufacturing multi-layer films are also disclosed herein. In particular, it is contemplated that any of the components, principles, and/or embodiments discussed above may be utilized in either a multi-layer film structure or a method of manufacturing and using the same. In some embodiments, the films are prepared using a triple bubble extrusion process. For example, the method can include extruding and blowing the film materials or layers into a calibration station or system where the extruded tube (or pretube or film precursor) is cooled. In some embodiments, the film materials are extruded and/or blown at temperatures of between about 200° C. and about 300° C. The extruded tube (or pretube or film precursor) can also be cooled to between about 3° C. and about 20° C.

The pretube or film precursor can then be heated using infrared heat to an orientation temperature. For example, in some embodiments, the pretube or film precursor is heated to an orientation temperature that is greater than about 85° C., greater than about 90° C., greater than about 95° C., or greater than about 100° C. In certain embodiments, the pretube or film precursor is heated to an orientation temperature that is between about 85° C. and about 120° C., between about 85° C. and about 115° C., between about 90° C. and about 110° C., between about 90° C. and about 105° C., or between about 95° C. and about 100° C. In other embodiments, the pretube or film precursor is heated to an orientation temperature that is between about 95° C. and about 115° C., between about 100° C. and about 105° C., and between about 100° C. and about 110° C. In particular embodiments, the pretube or film precursor can be heated with infrared heat to a temperature that is greater than that which can be obtained using heated or boiling water.

The heated pretube or film precursor can then be blown into an orientation bubble to achieve the above-mentioned orientation factors. Following orientation, the bubble or film precursor can be passed through a hot air chamber to heat set or anneal the bubble to form a multi-layer film having the desired shrinkage properties. Additional processing steps, and/or methods, can also be employed.

### EXAMPLES

The following examples are illustrative of embodiments of the present disclosure, as described above, and are not meant to be limiting in any way.

### Example 1

A first multi-layer film sample (Variable A) was prepared using a triple bubble manufacturing process as disclosed herein. Eleven layers of material were extruded and blown (at a temperature of between about 208° C. and about 291° C.) into a calibration system to form a pretube or film precursor. The pretube (or film precursor) was then cooled to a temperature of about 6° C. The pretube (or film precursor) was then heated using infrared heat to an orientation temperature of about 101° C. The heated pretube (or film precursor) was then blown into an orientation bubble to achieve an orientation factor of about 2.70 in the machine direction and about 3.42 in the cross-machine direction. Following orientation, the bubble was heat set (or annealed) to yield the following film structure:

Variable A:

| | Percent by | |
|---|---|---|
| | Volume of | |
| Film | the Film | Materials and Percent by Volume of the Film |
| Layer | (Vol %) | Layer (Vol %) |
| 1 | 10 | 100% PET (CumaStretch FX) |
| 2 | 5 | 100% Ethylene Copolymer Based Adhesive |
| | | (ADMER SF730E) |
| 3 | 9 | 70% Ethylene/Propylene/Butene Copolymer |
| | | (Adsyl 5c30f) |
| | | 30% Propylene-Ethylene Based Plastomer |
| | | (Versify 2200) |
| 4 | 9 | 70% Ethylene/Propylene/Butene Copolymer |
| | | (Adsyl 5c30f) |
| | | 30% Propylene-Ethylene Based Plastomer |
| | | (Versify 2200) |
| 5 | 9 | 70% Ethylene/Propylene/Butene Copolymer |
| | | (Adsyl 5c30f) |
| | | 30% Propylene-Ethylene Based Plastomer |
| | | (Versify 2200) |
| 6 | 9 | 70% Ethylene/Propylene/Butene Copolymer |
| | | (Adsyl 5c30f) |
| | | 30% Propylene-Ethylene Based Plastomer |
| | | (Versify 2200) |
| 7 | 9 | 70% Ethylene/Propylene/Butene Copolymer |
| | | (Adsyl 5c30f) |
| | | 30% Propylene-Ethylene Based Plastomer |
| | | (Versify 2200) |
| 8 | 5 | 100% Elastomer Based Adhesive (ADMER |
| | | AT1955) |
| 9 | 10 | 70% EVOH (38 mol % Ethylene) (EVAL H171B) |
| | | 30% Polyamide Terpolymer (EMS CF7) |
| 10 | 5 | 100% Elastomer Based Adhesive (ADMER |
| | | AT1955) |
| 11 | 20 | 47% Ethylene Octene Based Plastomer (Queo |
| | | 0203) |
| | | 49% Metallocene Ethylene-Hexene Copolymer |
| | | (Exeed 1018HA) |
| | | 4% Additives (e.g., slip and anti-block) |

It was observed that Variable A exhibited a good gloss and shiny exterior surface layer, with a measured gloss of about 92.3 units at 45°. Variable A was also biaxially oriented, as detailed above. Variable A also exhibited a heat shrinkability of about 47% in the cross-machine direction and about 46% in the machine direction at 200° F. The haze was also measured to be about 7.8%.

### Example 2

A second multi-layer film sample (Variable B) was prepared using a triple bubble manufacturing process as disclosed herein. Eleven layers of material were extruded and blown (at a temperature of between about 206° C. and about 291° C.) into a calibration system to form a pretube or film precursor. The pretube (or film precursor) was then cooled to a temperature of about 6° C. The pretube (or film precursor) was then heated using infrared heat to an orientation temperature of about 103° C. The heated pretube (or film precursor) was then blown into an orientation bubble to achieve an orientation factor of about 2.70 in the machine direction and about 3.48 in the cross-machine direction. Following orientation, the bubble was heat set (or annealed) to yield the following film structure:

Variable B:

| | Percent by | |
|---|---|---|
| | Volume of | |
| Film | the Film | Materials and Percent by Volume of the Film |
| Layer | (Vol %) | Layer (Vol %) |
| 1 | 10 | 100% PET (CumaStretch FX) |
| 2 | 5 | 100% Ethylene Copolymer Based Adhesive |
| | | (ADMER SF730E) |
| 3 | 9 | 70% Ethylene/Propylene/Butene Copolymer |
| | | (Adsyl 5c30f) |
| | | 30% Propylene-Ethylene Based Plastomer |
| | | (Versify 2200) |
| 4 | 9 | 70% Ethylene/Propylene/Butene Copolymer |
| | | (Adsyl 5c30f) |
| | | 30% Propylene-Ethylene Based Plastomer |
| | | (Versify 2200) |
| 5 | 9 | 70% Ethylene/Propylene/Butene Copolymer |
| | | (Adsyl 5c30f) |
| | | 30% Propylene-Ethylene Based Plastomer |
| | | (Versify 2200) |
| 6 | 9 | 70% Ethylene/Propylene/Butene Copolymer |
| | | (Adsyl 5c30f) |
| | | 30% Propylene-Ethylene Based Plastomer |
| | | (Versify 2200) |
| 7 | 9 | 70% Ethylene/Propylene/Butene Copolymer |
| | | (Adsyl 5c30f) |
| | | 30% Propylene-Ethylene Based Plastomer |
| | | (Versify 2200) |
| 8 | 5 | 100% Elastomer Based Adhesive (Admer |
| | | AT1955) |
| 9 | 10 | 70% EVOH (44 mol % Ethylene) (EVAL E171B) |
| | | 30% Polyamide Terpolymer (EMS CF7) |
| 10 | 5 | 100% Elastomer Based Adhesive Admer |
| | | AT1955) |
| 11 | 20 | 47% Ethylene Octene Based Plastomer (Queo |
| | | 0203) |
| | | 49% Metallocene Ethylene-Hexene Copolymer |
| | | (Exeed 1018HA) |
| | | 4% Additives (e.g., slip and anti-block) |

It was observed that Variable B exhibited a good gloss and shiny exterior surface layer, with a measured gloss of about 97.0 units at 45°. Variable B was also biaxially oriented, as detailed above. Variable B also exhibited a heat shrinkability of about 48% in the cross-machine direction and about 45% in the machine direction at 200° F. The haze was also measured to be about 6.0%.

### Example 3

A third multi-layer film sample (Variable 1) was prepared using a triple bubble manufacturing process as disclosed herein. Eleven layers of material were extruded and blown (at a temperature of between about 206° C. and about 272° C.) into a calibration system to form a pretube or film precursor. The pretube (or film precursor) was then cooled to a temperature of about 13° C. The pretube (or film precursor) was then heated using infrared heat to an orientation temperature of about 93° C. The heated pretube (or film precursor) was then blown into an orientation bubble to achieve an orientation factor of about 2.75 in the machine direction and about 3.33 in the cross-machine direction. Following orientation, the bubble was heat set (or annealed) to yield the following film structure:

Variable 1:

| | Percent by | |
|---|---|---|
| | Volume of | |
| Film | the Film | Materials and Percent by Volume of the Film |
| Layer | (Vol %) | Layer (Vol %) |
| 1 | 10 | 98% PET (CumaStretch FX) |
| | | 2% Additives/Processing Aids |
| 2 | 5 | 100% Ethylene Copolymer Based Adhesive |
| | | (SF730E) |
| 3 | 9 | 70% Ethylene/Propylene/Butene Copolymer |
| | | (Adsyl 5c30f) |
| | | 30% Propylene-Ethylene Based Plastomer |
| | | (Versify 2200) |
| 4 | 9 | 70% Ethylene/Propylene/Butene Copolymer |
| | | (Adsyl 5c30f) |
| | | 30% Propylene-Ethylene Based Plastomer |
| | | (Versify 2200) |
| 5 | 9 | 70% Ethylene/Propylene/Butene Copolymer |
| | | (Adsyl 5c30f) |
| | | 30% Propylene-Ethylene Based Plastomer |
| | | (Versify 2200) |
| 6 | 9 | 70% Ethylene/Propylene/Butene Copolymer |
| | | (Adsyl 5c30f) |
| | | 30% Propylene-Ethylene Based Plastomer |
| | | (Versify 2200) |
| 7 | 9 | 70% Ethylene/Propylene/Butene Copolymer |
| | | (Adsyl 5c30f) |
| | | 30% Propylene-Ethylene Based Plastomer |
| | | (Versify 2200) |
| 8 | 5 | 100% Elastomer Based Adhesive (Admer |
| | | AT1955) |
| 9 | 10 | 100% EVOH (38 mol % Ethylene) (Soarnol |
| | | GH3804B) |
| 10 | 5 | 100% Elastomer Based Adhesive Admer |
| | | AT1955) |
| 11 | 20 | 96% Ethylene Octene Based Plastomer (Queo |
| | | 0203) |
| | | 4% Additives (e.g., slip and anti-block) |

It was observed that Variable 1 exhibited a good gloss and shiny exterior surface layer. Variable 1 was also biaxially oriented, as detailed above.

### Example 4

A fourth multi-layer film sample (Variable 2) was prepared using a triple bubble manufacturing process as disclosed herein. Eleven layers of material were extruded and blown (at a temperature of between about 206° C. and about 272° C.) into a calibration system to form a pretube or film precursor. The pretube (or film precursor) was then cooled to a temperature of about 12° C. The pretube (or film precursor) was then heated using infrared heat to an orientation temperature of about 92° C. The heated pretube (or film precursor) was then blown into an orientation bubble to achieve an orientation factor of about 2.75 in the machine direction and about 3.33 in the cross-machine direction. Following orientation, the bubble was heat set (or annealed) to yield the following film structure:

Variable 2:

| | Percent by | |
|---|---|---|
| | Volume of | |
| Film | the Film | Materials and Percent by Volume of the Film |
| Layer | (Vol %) | Layer (Vol %) |
| 1 | 10 | 98% PET (CumaStretch FX) |
| | | 2% Additives/Processing Aids |
| 2 | 5 | 100% Ethylene Copolymer Based Adhesive |
| | | (SF730E) |
| 3 | 9 | 70% Ethylene/Propylene/Butene Copolymer |
| | | (Adsyl 5c30f) |
| | | 30% Propylene-Ethylene Based Plastomer |
| | | (Versify 2200) |
| 4 | 9 | 70% Ethylene/Propylene/Butene Copolymer |
| | | (Adsyl 5c30f) |
| | | 30% Propylene-Ethylene Based Plastomer |
| | | (Versify 2200) |
| 5 | 9 | 70% Ethylene/Propylene/Butene Copolymer |
| | | (Adsyl 5c30f) |
| | | 30% Propylene-Ethylene Based Plastomer |
| | | (Versify 2200) |
| 6 | 9 | 70% Ethylene/Propylene/Butene Copolymer |
| | | (Adsyl 5c30f) |
| | | 30% Propylene-Ethylene Based Plastomer |
| | | (Versify 2200) |
| 7 | 9 | 70% Ethylene/Propylene/Butene Copolymer |
| | | (Adsyl 5c30f) |
| | | 30% Propylene-Ethylene Based Plastomer |
| | | (Versify 2200) |
| 8 | 5 | 100% Elastomer Based Adhesive (Admer |
| | | AT1955) |
| 9 | 10 | 100% EVOH (38 mol% Ethylene) (Soarnol |
| | | GH3804B) |
| 10 | 5 | 100% Elastomer Based Adhesive Admer |
| | | AT1955) |
| 11 | 20 | 86% Ethylene Octene Based Plastomer (Queo |
| | | 0203) |
| | | 10% Metallocene Ethylene-Hexene Copolymer |
| | | (Exeed 1018HA) |
| | | 4% Additives (e.g., slip and anti-block) |

It was observed that Variable 2 exhibited a good gloss and shiny exterior surface layer, with a measured gloss of about 88.3 units at 45°. Variable 2 was also biaxially oriented, as detailed above. Variable 2 also exhibited a heat shrinkability of about 50% in the cross-machine direction and about 49% in the machine direction at 200° F. The haze was also measured to be about 7.6%, and the clarity was measured to be about 86.5%.

### Example 5

A fifth multi-layer film sample (Variable 4) was prepared using a triple bubble manufacturing process as disclosed herein. Eleven layers of material were extruded and blown (at a temperature of between about 206° C. and about 272° C.) into a calibration system to form a pretube or film precursor. The pretube (or film precursor) was then cooled to a temperature of about 12° C. The pretube (or film precursor) was then heated using infrared heat to an orientation temperature of about 92° C. The heated pretube (or film precursor) was then blown into an orientation bubble to achieve an orientation factor of about 2.75 in the machine direction and about 3.33 in the cross-machine direction. Following orientation, the bubble was heat set (or annealed) to yield the following film structure:

Variable 4:

| | Percent by | |
|---|---|---|
| | Volume of | |
| Film | the Film | Materials and Percent by Volume of the Film |
| Layer | (Vol %) | Layer (Vol %) |
| 1 | 10 | 98% PET (CumaStretch FX) |
| | | 2% Additives/Processing Aids |
| 2 | 8 | 100% Ethylene Copolymer Based Adhesive |
| | | (SF730E) |
| 3 | 7 | 70% Ethylene/Propylene/Butene Copolymer |
| | | (Adsyl 5c30f) |
| | | 30% Propylene-Ethylene Based Plastomer |
| | | (Versify 2200) |
| 4 | 7 | 70% Ethylene/Propylene/Butene Copolymer |
| | | (Adsyl 5c30f) |
| | | 30% Propylene-Ethylene Based Plastomer |
| | | (Versify 2200) |
| 5 | 7 | 70% Ethylene/Propylene/Butene Copolymer |
| | | (Adsyl 5c30f) |
| | | 30% Propylene-Ethylene Based Plastomer |
| | | (Versify 2200) |
| 6 | 7 | 70% Ethylene/Propylene/Butene Copolymer |
| | | (Adsyl 5c30f) |
| | | 30% Propylene-Ethylene Based Plastomer |
| | | (Versify 2200) |
| 7 | 8 | 70% Ethylene/Propylene/Butene Copolymer |
| | | (Adsyl 5c30f) |
| | | 30% Propylene-Ethylene Based Plastomer |
| | | (Versify 2200) |
| 8 | 8 | 100% Elastomer Based Adhesive (Admer |
| | | AT1955) |
| 9 | 10 | 100% EVOH (38 mol % Ethylene) (Soarnol |
| | | GH3804B) |
| 10 | 8 | 100% Elastomer Based Adhesive Admer |
| | | AT1955) |
| 11 | 20 | 86% Ethylene Octene Based Plastomer (Queo |
| | | 0203) |
| | | 10% Metallocene Ethylene-Hexene Copolymer |
| | | (Exeed 1018HA) |
| | | 4% Additives (e.g., slip and anti-block) |

It was observed that Variable 4 exhibited a good gloss and shiny exterior surface layer, with a measured gloss of about 92.1 units at 45°. Variable 4 was also biaxially oriented, as detailed above. Variable 4 also exhibited a heat shrinkability of about 50% in the cross-machine direction and about 50% in the machine direction at 200° F. The haze was also measured to be about 6.7%, and the clarity was measured to be about 89.8%.

### Example 6

A sixth multi-layer film sample (Variable 5) was prepared using a triple bubble manufacturing process as disclosed herein. Eleven layers of material were extruded and blown (at a temperature of between about 205° C. and about 272° C.) into a calibration system to form a pretube or film precursor. The pretube (or film precursor) was then cooled to a temperature of about 12° C. The pretube (or film precursor) was then heated using infrared heat to an orientation temperature of about 92° C. The heated pretube (or film precursor) was then blown into an orientation bubble to achieve an orientation factor of about 2.75 in the machine direction and about 3.33 in the cross-machine direction. Following orientation, the bubble was heat set (or annealed) to yield the following film structure:

Variable 5:

| | Percent by | |
|---|---|---|
| | Volume of | |
| Film | the Film | Materials and Percent by Volume of the Film |
| Layer | (Vol %) | Layer (Vol %) |
| 1 | 15 | 98% PET (CumaStretch FX) |
| | | 2% Additives/Processing Aids |
| 2 | 8 | 100% Ethylene Copolymer Based Adhesive |
| | | (SF730E) |
| 3 | 7 | 70% Ethylene/Propylene/Butene Copolymer |
| | | (Adsyl 5c30f) |
| | | 30% Propylene-Ethylene Based Plastomer |
| | | (Versify 2200) |
| 4 | 6 | 70% Ethylene/Propylene/Butene Copolymer |
| | | (Adsyl 5c30f) |
| | | 30% Propylene-Ethylene Based Plastomer |
| | | (Versify 2200) |
| 5 | 6 | 70% Ethylene/Propylene/Butene Copolymer |
| | | (Adsyl 5c30f) |
| | | 30% Propylene-Ethylene Based Plastomer |
| | | (Versify 2200) |
| 6 | 6 | 70% Ethylene/Propylene/Butene Copolymer |
| | | (Adsyl 5c30f) |
| | | 30% Propylene-Ethylene Based Plastomer |
| | | (Versify 2200) |
| 7 | 6 | 70% Ethylene/Propylene/Butene Copolymer |
| | | (Adsyl 5c30f) |
| | | 30% Propylene-Ethylene Based Plastomer |
| | | (Versify 2200) |
| 8 | 8 | 100% Elastomer Based Adhesive (Admer |
| | | AT1955) |
| 9 | 10 | 100% EVOH (38 mol % Ethylene) (Soarnol |
| | | GH3804B) |
| 10 | 8 | 100% Elastomer Based Adhesive Admer |
| | | AT1955) |
| 11 | 20 | 86% Ethylene Octene Based Plastomer (Queo |
| | | 0203) |
| | | 10% Metallocene Ethylene-Hexene Copolymer |
| | | (Exeed 1018HA) |
| | | 4% Additives (e.g., slip and anti-block) |

It was observed that Variable 5 exhibited a good gloss and shiny exterior surface layer, with a measured gloss of about 89.3 units at 45°. Variable 5 was also biaxially oriented, as detailed above. Variable 5 also exhibited a heat shrinkability of about 53% in the cross-machine direction and about 53% in the machine direction at 200° F. The haze was also measured to be about 7.5%, and the clarity was measured to be about 87.4%.

### Example 7

A seventh multi-layer film sample (Variable 6) was prepared using a triple bubble manufacturing process as disclosed herein. Eleven layers of material were extruded and blown (at a temperature of between about 205° C. and about 273° C.) into a calibration system to form a pretube or film precursor. The pretube (or film precursor) was then cooled to a temperature of about 12° C. The pretube (or film precursor) was then heated using infrared heat to an orientation temperature of about 92° C. The heated pretube (or film precursor) was then blown into an orientation bubble to achieve an orientation factor of about 2.75 in the machine direction and about 3.33 in the cross-machine direction. Following orientation, the bubble was heat set (or annealed) to yield the following film structure:

Variable 6:

| | Percent by | |
|---|---|---|
| | Volume of | |
| Film | the Film | Materials and Percent by Volume of the Film |
| Layer | (Vol %) | Layer (Vol %) |
| 1 | 15 | 98% PET (CumaStretch FX) |
| | | 2% Additives/Processing Aids |
| 2 | 8 | 100% Ethylene Copolymer Based Adhesive |
| | | (SF730E) |
| 3 | 6 | 70% Ethylene/Propylene/Butene Copolymer |
| | | (Adsyl 5c30f) |
| | | 30% Propylene-Ethylene Based Plastomer |
| | | (Versify 2200) |
| 4 | 5 | 70% Ethylene/Propylene/Butene Copolymer |
| | | (Adsyl 5c30f) |
| | | 30% Propylene-Ethylene Based Plastomer |
| | | (Versify 2200) |
| 5 | 5 | 70% Ethylene/Propylene/Butene Copolymer |
| | | (Adsyl 5c30f) |
| | | 30% Propylene-Ethylene Based Plastomer |
| | | (Versify 2200) |
| 6 | 5 | 70% Ethylene/Propylene/Butene Copolymer |
| | | (Adsyl 5c30f) |
| | | 30% Propylene-Ethylene Based Plastomer |
| | | (Versify 2200) |
| 7 | 5 | 70% Ethylene/Propylene/Butene Copolymer |
| | | (Adsyl 5c30f) |
| | | 30% Propylene-Ethylene Based Plastomer |
| | | (Versify 2200) |
| 8 | 8 | 100% Elastomer Based Adhesive (Admer |
| | | AT1955) |
| 9 | 10 | 100% EVOH (38 mol % Ethylene) (Soarnol |
| | | GH3804B) |
| 10 | 8 | 100% Elastomer Based Adhesive Admer |
| | | AT1955) |
| 11 | 25 | 86% Ethylene Octene Based Plastomer (Queo |
| | | 0203) |
| | | 10% Metallocene Ethylene-Hexene Copolymer |
| | | (Exeed 1018HA) |
| | | 4% Additives (e.g., slip and anti-block) |

It was observed that Variable 6 exhibited a good gloss and shiny exterior surface layer, with a measured gloss of about 90.8 units at 45°. Variable 6 was also biaxially oriented, as detailed above. Variable 6 also exhibited a heat shrinkability of about 53% in the cross-machine direction and about 51% in the machine direction at 200° F. The haze was also measured to be about 7.3%, and the clarity was measured to be about 88.1%.

### Example 8

An eighth multi-layer film sample (Variable 7) was prepared using a triple bubble manufacturing process as disclosed herein. Eleven layers of material were extruded and blown (at a temperature of between about 205° C. and about 273° C.) into a calibration system to form a pretube or film precursor. The pretube (or film precursor) was then cooled to a temperature of about 12° C. The pretube (or film precursor) was then heated using infrared heat to an orientation temperature of about 92° C. The heated pretube (or film precursor) was then blown into an orientation bubble to achieve an orientation factor of about 2.75 in the machine direction and about 3.5 in the cross-machine direction. Following orientation, the bubble was heat set (or annealed) to yield the following film structure:

Variable 7 (1.8 mil total film thickness):

| | Percent by | |
|---|---|---|
| | Volume of | |
| Film | the Film | Materials and Percent by Volume of the Film |
| Layer | (Vol %) | Layer (Vol %) |
| 1 | 10 | 98% PET (DAK) |
| | | 2% Additives/Processing Aids |
| 2 | 8 | 100% Ethylene Copolymer Based Adhesive |
| | | (SF730E) |
| 3 | 8 | 100% Ethylene Vinyl Acetate (18% wt Vinyl |
| | | Acetate) |
| 4 | 8 | 100% Ethylene Vinyl Acetate (18% wt Vinyl |
| | | Acetate) |
| 5 | 7 | 100% Ethylene Vinyl Acetate (18% wt Vinyl |
| | | Acetate) |
| 6 | 7 | 100% Ethylene Vinyl Acetate (18% wt Vinyl |
| | | Acetate) |
| 7 | 7 | 100% Ethylene Vinyl Acetate (18% wt Vinyl |
| | | Acetate) |
| 8 | 5 | 100% Elastomer Based Adhesive (Admer |
| | | SF755A) |
| 9 | 10 | 95% EVOH (38 mol % Ethylene) (Soarnol |
| | | GH3804B) |
| | | 5% Acid Modified Maleic Anhydride Grafted |
| | | Ethylene Alpha Olefin Copolymer (Tafmer |
| | | MD715) |
| 10 | 5 | 100% Elastomer Based Adhesive (Admer |
| | | SF755A) |
| 11 | 25 | 66% Ethylene Octene Based Plastomer (Queo |
| | | 0203) |
| | | 30% Metallocene Ethylene-Hexene Copolymer |
| | | (Exeed 1018HA) |
| | | 3% Additives (e.g., slip and anti-block) |

It was observed that Variable 7 exhibited a good gloss and shiny exterior surface layer, with a measured gloss of about 92.5 units at 45°. Variable 7 was also biaxially oriented, as detailed above. Variable 7 also exhibited a heat shrinkability of about 50% in the cross-machine direction and about 50% in the machine direction at 200° F. The haze was also measured to be about 7.1%, and the clarity was measured to be about 86.7%. Variable 7 also exhibited an increased softness (or decreased stiffness) when touched or contacted.

### Example 9

A ninth multi-layer film sample (Variable 8) was prepared using a triple bubble manufacturing process as disclosed herein. Eleven layers of material were extruded and blown (at a temperature of between about 205° C. and about 273° C.) into a calibration system to form a pretube or film precursor. The pretube (or film precursor) was then cooled to a temperature of about 12° C. The pretube (or film precursor) was then heated using infrared heat to an orientation temperature of about 92° C. The heated pretube (or film precursor) was then blown into an orientation bubble to achieve an orientation factor of about 2.75 in the machine direction and about 3.5 in the cross-machine direction. Following orientation, the bubble was heat set (or annealed) to yield the following film structure:

Variable 8 (2.0 mil total film thickness):

| | Percent by | |
|---|---|---|
| | Volume of | |
| Film | the Film | Materials and Percent by Volume of the Film |
| Layer | (Vol %) | Layer (Vol %) |
| 1 | 10 | 98% PET (DAK) |
| | | 2% Additives/Processing Aids |
| 2 | 8 | 100% Ethylene Copolymer Based Adhesive |
| | | (SF730E) |
| 3 | 8 | 100% Ethylene Vinyl Acetate (18% wt Vinyl |
| | | Acetate) |
| 4 | 8 | 100% Ethylene Vinyl Acetate (18% wt Vinyl |
| | | Acetate) |
| 5 | 7 | 100% Ethylene Vinyl Acetate (18% wt Vinyl |
| | | Acetate) |
| 6 | 7 | 100% Ethylene Vinyl Acetate (18% wt Vinyl |
| | | Acetate) |
| 7 | 7 | 100% Ethylene Vinyl Acetate (18% wt Vinyl |
| | | Acetate) |
| 8 | 5 | 100% Elastomer Based Adhesive (Admer |
| | | SF755A) |
| 9 | 10 | 92% EVOH (38 mol % Ethylene) (Soarnol |
| | | GH3804B) |
| | | 8% Acid Modified Maleic Anhydride Grafted |
| | | Ethylene Alpha Olefin Copolymer (Tafmer |
| | | MD715) |
| 10 | 5 | 100% Elastomer Based Adhesive (Admer |
| | | SF755A) |
| 11 | 25 | 66% Ethylene Octene Based Plastomer (Queo |
| | | 0203) |
| | | 30% Metallocene Ethylene-Hexene Copolymer |
| | | (Exeed 1018HA) |
| | | 3% Additives (e.g., slip and anti-block) |

It was observed that Variable 8 exhibited a good gloss and shiny exterior surface layer, with a measured gloss of about 95.9 units at 45°. Variable 8 was also biaxially oriented, as detailed above. Variable 8 also exhibited a heat shrinkability of about 50% in the cross-machine direction and about 50% in the machine direction at 200° F. The haze was also measured to be about 7.0%, and the clarity was measured to be about 91.5%. Variable 8 also exhibited an increased softness (or decreased stiffness) when touched or contacted.

Throughout this specification, any reference to “one embodiment,” “an embodiment,” or “the embodiment” means that a particular feature, structure, or characteristic described in connection with that embodiment is included in at least one embodiment. Thus, the quoted phrases, or variations thereof, as recited throughout this specification are not necessarily all referring to the same embodiment.

Similarly, it should be appreciated that in the above description of embodiments, various features are sometimes grouped together in a single embodiment, figure, or description thereof for the purpose of streamlining the disclosure. This method of disclosure, however, is not to be interpreted as reflecting an intention that any claim require more features than those expressly recited in that claim. Rather, as the following claims reflect, inventive aspects lie in a combination of fewer than all features of any single foregoing disclosed embodiment.

The claims following this written disclosure are hereby expressly incorporated into the present written disclosure, with each claim standing on its own as a separate embodiment. This disclosure includes all permutations of the independent claims with their dependent claims. Moreover, additional embodiments capable of derivation from the independent and dependent claims that follow are also expressly incorporated into the present written description.

As used herein, the term “about” means within 20%, within 15%, within 10%, within 5%, or within 1% or less of a given value or range. Further, all ranges include both endpoints. Additionally, for references to approximations, such as by use of the term “about,” it is to be understood that, in some embodiments, the value, feature, or characteristic may be specified without approximation. For example, where qualifiers such as “about” and “substantially” are used, these terms include within their scope the qualified words in the absence of their qualifiers.

Without further elaboration, it is believed that one skilled in the art can use the preceding description to utilize the invention to its fullest extent. The claims and embodiments disclosed herein are to be construed as merely illustrative and exemplary, and not a limitation of the scope of the present disclosure in any way. It will be apparent to those having ordinary skill in the art, with the aid of the present disclosure, that changes may be made to the details of the above-described embodiments without departing from the underlying principles of the disclosure herein. In other words, various modifications and improvements of the embodiments specifically disclosed in the description above are within the scope of the appended claims. The scope of the invention is therefore defined by the following claims and their equivalents.

1. A heat shrinkable multi-layer film, comprising:
an outer layer comprising at least one of polyethylene terephthalate, polyamide, or polypropylene;
an inner layer comprising at least one of a polyolefin copolymer, a plastomer, an elastomer, or a terpolymer;
a barrier layer comprising ethylene vinyl alcohol and an acid modified polyolefin; and
a sealant layer comprising a sealant material;
wherein the multi-layer film comprises an orientation factor of between about 2.0 and about 3.5 in the machine direction and between about 2.8 and about 4.0 in the cross-machine direction, wherein the multi-layer film is oriented at a temperature that is between about 85° C. and about 120° C.

2. The multi-layer film of claim 1, wherein the inner layer comprises at least one of a polyolefin plastomer, a polyolefin elastomer, a polyolefin terpolymer, an ionomer, or ethylene vinyl acetate.

3. The multi-layer film of claim 2, wherein the multi-layer film comprises ethylene vinyl acetate comprising between about 5% and about 50%, between about 7.5% and about 40%, between about 7.5% and about 30%, between about 7.5% and about 25%, between about 7.5% and about 20%, between about 10% and about 20%, or between about 10% and about 18% by weight of vinyl acetate.

4. The multi-layer film of claim 2, wherein the inner layer comprises a plastomer comprising propylene-ethylene or a derivative thereof.

5. The multi-layer film of claim 1, wherein the barrier layer comprises a blend of ethylene vinyl alcohol and an acid modified maleic anhydride grafted ethylene alpha olefin copolymer.

6. The multi-layer film of claim 5, wherein the barrier layer comprises between about 1% and about 15%, between about 1% and about 10%, or between about 3% and about 8% by volume of acid modified maleic anhydride grafted ethylene alpha olefin copolymer.

7. The multi-layer film of claim 1, wherein the barrier layer comprises an acid modified polyolefin having a melt flow rate of between about 1.2 and about 1.8 g/10 min at 190° C./2.16 kg as determined by ASTM D1238.

8. The multi-layer film of claim 1, wherein the multi-layer film is devoid of a polyamide.

9. The multi-layer film of claim 1, wherein the multi-layer film is heat shrinkable in each of the cross-machine and machine directions by between about 30% and about 80%, between about 35% and about 75%, between about 40% and about 70%, between about 45% and about 70%, between about 45% and about 65%, or between about 50% and about 65%, at 200° F.

10. The multi-layer film of claim 1, wherein the multi-layer film comprises an orientation factor of between about 2.0 and about 3.5, between about 2.2 and about 3.3, between about 2.4 and about 3.0, or between about 2.4 and about 2.8 in the machine direction and between about 2.8 and about 4.0, between about 3.0 and about 4.0, between about 3.2 and about 3.8, or between about 3.4 and about 3.6 in the cross-machine direction.

11. The multi-layer film of claim 1, wherein the multi-layer film comprises a gloss of between about 85% and about 100%, or between about 88% and about 95%, measured in accordance with ASTM D-2457.

12. The multi-layer film of claim 1, wherein the multi-layer film comprises a haze of between about 5% and about 10%, or between about 6% and about 8%, measured in accordance with ASTM D1003.

13. The multi-layer film of claim 1, wherein the multi-layer film comprises a peak seal strength of between about 8 lbs and about 15 lbs, or between about 10 lbs and about 13 lbs, measured in accordance with ASTM F-88.

14. A method of manufacturing a multi-layer film, comprising:
extruding a plurality of layers to form a film precursor;
heating the film precursor to an orientation temperature that is between about 85° C. and about 120° C. using infrared heat;
biaxially orienting the film precursor; and
annealing the film precursor to form the multi-layer film.

15. The method of claim 14, wherein the multi-layer film comprises:
an outer layer comprising at least one of polyethylene terephthalate, polyamide, or polypropylene;
an inner layer comprising at least one of a polyolefin copolymer, a plastomer, an elastomer, or a terpolymer;
a barrier layer comprising ethylene vinyl alcohol and an acid modified polyolefin; and
a sealant layer comprising a sealant material.

16. The method of claim 14 or 15, wherein the film precursor is heated using infrared heat to an orientation temperature that is between about 90° C. and about 115° C., or between about 90° C. and about 110° C.

17. The method of claim 14, wherein biaxially orienting the film precursor comprises blowing the film precursor into an orientation bubble.

18. A heat shrinkable multi-layer film, comprising:
an outer layer comprising polyethylene terephthalate;
an inner layer comprising ethylene vinyl acetate or a blend comprising an ethylene propylene butene copolymer and a propylene-ethylene based plastomer;
a barrier layer comprising ethylene vinyl alcohol and an acid modified polyolefin; and
a sealant layer comprising an ethylene octene based plastomer and a metallocene ethylene-hexene copolymer;
wherein the multi-layer film comprises an orientation factor of between about 2.0 and about 3.5 in the machine direction and between about 2.8 and about 4.0 in the cross-machine direction.

19. The multi-layer film of claim 18, wherein the sealant layer comprises between about 50% and about 99% by volume ethylene octene based plastomer and between about 1% and about 50% by volume metallocene ethylene-hexene copolymer.

20. A method of manufacturing the multi-layer film of claim 18, comprising:
extruding a plurality of layers to form a film precursor;
heating the film precursor to an orientation temperature that is between about 85° C. and about 120° C. using infrared heat;
biaxially orienting the film precursor to an orientation of between about 2.0 and about 3.5 in the machine direction and between about 2.8 and about 4.0 in the cross-machine direction; and
annealing the film precursor to form the multi-layer film.
